(19) United States
(12) Patent Application Publication
(10) Pub. No.: US 2020/0007382 A1
(43) Pub. Date: Jan. 2, 2020

(54) ACCELERATED CONVERGENCE IN NETWORKS WITH CLOS TOPOLOGIES

(71) Applicant: Microsoft Technology Licensing, LLC, Redmond, WA (US)

(72) Inventors: Zhenggen Xu, Sunnyvale, CA (US); Shafagh Zandi, San Francisco, CA (US); Sadaf Fardeen, Los Altos, CA (US)

(73) Assignee: Microsoft Technology Licensing, LLC, Redmond, WA (US)

(21) Appl. No.: 16/022,295

(22) Filed: Jun. 28, 2018

(51) Int. Cl. H04L 12/24; H04L 12/707; H04L 12/933

(52) U.S. Cl. CPC H04L 41/0654; H04L 49/1515; H04L 45/22

(57) ABSTRACT

The disclosed embodiments provide a system for managing a broken link in a network with a Clos topology. During operation, the system detects, at a first node in the network, a broken link between the first node and a second node in the network. Next, the system identifies one or more upstream nodes in the network that can make routing decisions to avoid the broken link. The system then transmits a first indication of the broken link to the upstream node(s) without propagating the first indication to remaining nodes in the network. Finally, the system updates, based on the first indication, routing information at the upstream node(s) to avoid the broken link.

### BACKGROUND

### Field

The disclosed embodiments relate to techniques for managing changes in connectivity in networks. More specifically, the disclosed embodiments relate to techniques for providing accelerated convergence in networks with Clos topologies.

### Related Art

Switch fabrics with Clos topologies are commonly used to route traffic within data centers. For example, network traffic may be transmitted to, from, or between servers in a data center using a layer of “leaf” switches connected to a fabric of “spine” switches. Traffic from a first server to a second server may be received at a first leaf switch to which the first server is connected, routed or switched through the fabric to a second leaf switch, and forwarded from the second leaf switch to the second server.

When a change in connectivity is detected in a switch fabric or other type of network, the change is propagated from the node that detected the change to all other nodes in the network. The nodes may then be required to recalculate routes and build new routing tables based on the updated network topology. If the change in connectivity includes a downed or broken link, traffic within the network may be routed suboptimally, dropped, or black holed until all nodes in the network have recalculated their routes and converged onto a common view of the network topology. Moreover, a “flapping” interface that continually toggles between up and down may cause conflicting information to be propagated across the network, which may prevent the nodes from converging on the network topology until the flapping state is detected and the interface is disabled.

Consequently, adverse effects from downed or broken links in networks may be mitigated by techniques for accelerating convergence of the networks.

### BRIEF DESCRIPTION OF THE FIGURES

FIG. 1A shows a switch fabric in accordance with the disclosed embodiments.

FIG. 1B shows a switch fabric in accordance with the disclosed embodiments.

FIG. 2 shows a flowchart illustrating a process of managing a broken link in a network with a Clos topology in accordance with the disclosed embodiments.

FIG. 3 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor (including a dedicated or shared processor core) that executes a particular software module or a piece of code at a particular time, and/or other programmable-logic devices now known or later developed. When the hardware modules or apparatus are activated, they perform the methods and processes included within them.

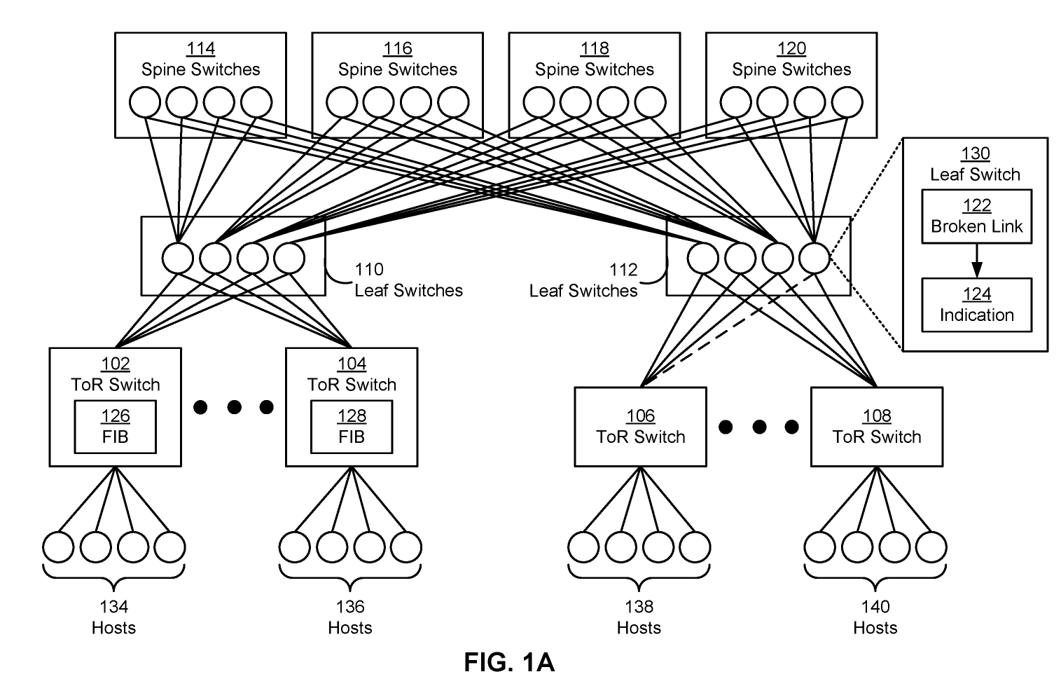

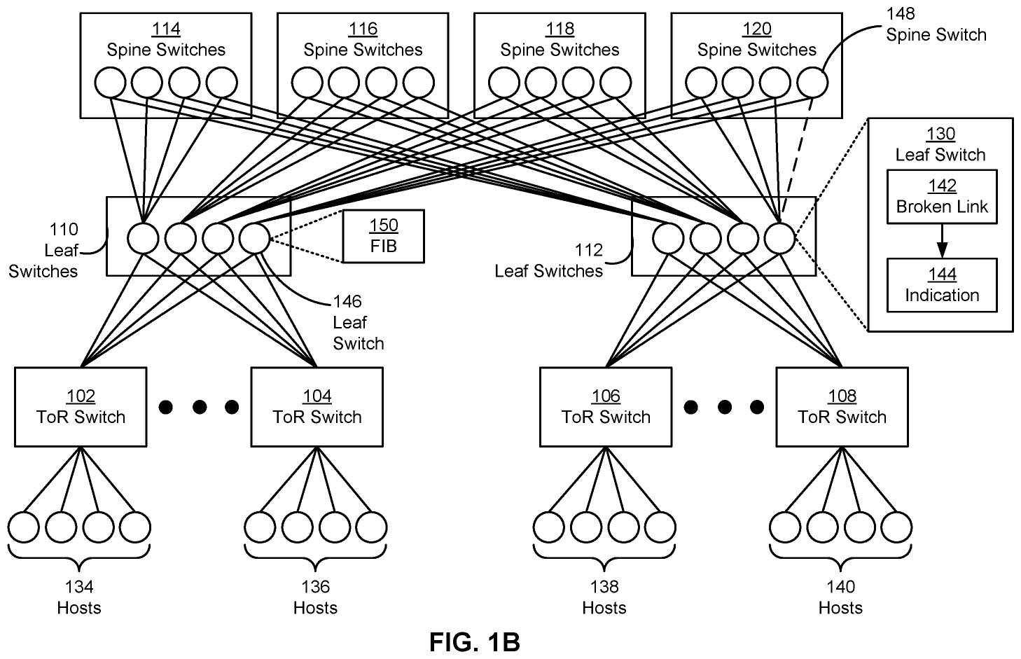

The disclosed embodiments provide a method, apparatus, and system for accelerating convergence in networks with Clos topologies. As shown in FIGS. 1A-1B, a network with a Clos topology may include a switch fabric. The switch fabric includes a number of top of rack (ToR) switches 102-108 that are connected to multiple sets of leaf switches 110-112 via a set of physical and/or logical links. In turn, leaf switches 110-112 are connected to multiple sets of spine switches 114-120 in the switch fabric via another set of physical and/or logical links.

The switch fabric may be used to route traffic to, from, or between nodes connected to the switch fabric, such as a set of hosts 134-140 connected to ToR switches 102-108. For example, the switch fabric may include an InfiniBand (InfiniBandTM is a registered trademark of InfiniBand Trade Association Corp.), Ethernet, Peripheral Component Interconnect Express (PCIe), and/or other interconnection mechanism among compute and/or storage nodes in a data center. Within the data center, the switch fabric may route north-south network flows between external client devices and servers connected to ToR switches 102-108 and/or east-west network flows between the servers.

Switches in the switch fabric may be connected in the Clos topology. First, each ToR switch 102-108 provides connection points to the switch fabric for a set of hosts 134-140 (e.g., servers, storage arrays, etc.). For example, each ToR switch 102-108 may connect to a set of servers in the same physical rack as the ToR switch, and each server may connect to a single ToR switch in the same physical rack.

Next, ToR switches 102-104 are connected to one set of leaf switches 110, and ToR switches 106-108 are connected to a different set of leaf switches 112. ToR switches 102-104 and leaf switches 110 may form one point of delivery (pod) in the switch fabric, and ToR switches 106-108 and leaf switches 112 may form a different pod in the switch fabric. ToR switches in each pod are fully connected to the leaf switches in the same pod, so that each ToR switch is connected to every leaf switch in the pod and every leaf switch is connected to every ToR switch in the pod.

Pods containing different sets of leaf switches 110-112 and ToR switches 102-108 are then connected by multiple sets of spine switches 114-120. Each set of spine switches 114-120 may represent an independent fabric “plane” that routes traffic between pods in the switch fabric. In addition, each plane of spine switches 114-120 may be connected to a different leaf switch from each pod. For example, spine switches 114 may connect a first switch in leaf switches 110 to a first switch in leaf switches 112, spine switches 116 may connect a second switch in leaf switches 110 to a second switch in leaf switches 112, spine switches 118 may connect a third switch in leaf switches 110 to a third switch in leaf switches 112, and spine switches 120 may connect a fourth switch in leaf switches 110 to a fourth switch in leaf switches 112.

As a result, connections between independent pods of ToR switches 102-108 and leaf switches 110-112 and independent planes of spine switches 114-120 may allow network flows to be transmitted across multiple paths within the switch fabric. At the same time, the switch fabric may be scaled by adding individual pods and/or planes may be added to the fabric without changing existing connections in the switch fabric.

When a link between two switches is broken or down, a change in the topology of the switch fabric is typically detected by one or more switches and communicated to next-hop switches in the switch fabric. All switches in the next hop may then detect all possible reachabilities in the fabric, remove the downed link, and propagate the change to their next-hop switches in the switch fabric. While the switch fabric converges to the change in topology, traffic within the network may be routed suboptimally, dropped, or black holed. Moreover, a link flap error that continually toggles a link between up and down may cause conflicting information to be propagated across the switch fabric, which may prevent convergence until the flapping state is detected and the interface causing the error is disabled manually or automatically. Consequently, a downed link in the switch fabric may adversely affect the delivery of traffic within the switch fabric for a period of seconds to minutes.

In one or more embodiments, the switch fabric of FIGS. 1A-1B includes functionality to reduce network convergence time in response to broken or downed links in the switch fabric. More specifically, a switch that detects a downed link may directly notify other, upstream switches that can make routing decisions to avoid the downed link. The upstream switches may use notifications of the downed link to update locally stored routing information so that traffic can be routed in a way that avoids the downed link. Such updating of routing information may be performed before remaining switches in the fabric have converged in response to the downed link, thereby reducing suboptimal routing, black holing, and/or dropping of traffic prior to convergence in the switch fabric.

Those skilled in the art will appreciate that downed or broken links in the switch fabric of FIGS. 1A-1B may occur between adjacent tiers of the topology. For example, a downed or broken link may occur between a

ToR switch and a leaf switch or between a leaf switch and a spine switch. In turn, switches in the switch fabric may detect and/or handle the downed or broken link based on the location of the link in the topology.

As shown in FIG. 1A, a broken link 122 between ToR switch 106 and a leaf switch 130 in leaf switches 112 is detected at leaf switch 130. Leaf switch 130 may determine that upstream ToR switches 102-104 connected to leaf switches 110 can make routing decisions that avoid broken link 122 because the upstream ToR switches can route traffic from hosts 134-136 to hosts 138-140 through planes of spine switches 114-118 that avoid broken link 122.

As a result, leaf switch 130 and/or another component may communicate an indication 124 of broken link 122 to ToR switches 102-104 connected to leaf switches 110. For example, leaf switch 130 may use an in-band protocol such as Border Gateway Protocol—Link State (BGP-LS) and/or RPC (Remote Procedure Calls) to transmit indication 124 to ToR switches 102-104 (e.g., via spine switches 120 and another leaf switch in leaf switches 110 that is connected to spine swithces 120). In another example, leaf switch 130 may transmit indication 124 to a centralized controller and/or route reflector (not shown) for the switch fabric, and the centralized controller and/or route reflector may relay indication 124 to ToR switches 102-104.

In turn, ToR switches 102-104 may update routing information in their local forwarding information bases (FIBs) 126-128 to avoid broken link 122. For example, each ToR switch 102-104 may remove routes that include broken link 122 (e.g., routes that include the plane of spine switches 120) from a local FIB 126-128. Because updating of FIBs 126-128 is performed much more quickly than conventional topology-driven network convergence in response to broken link 122, suboptimal routing, dropping, and/or black holing of network traffic as a result of broken link 122 may be reduced, thereby improving the performance, use, and/or fault tolerance of the switch fabric.

Leaf switch 130 and/or another component of the switch fabric may propagate a subsequent indication of broken link 122 to remaining switches in the switch fabric. For example, the component may propagate a message containing a change in connectivity resulting from broken link 122 to all other switches in the switch fabric. The switches may then calculate reachabilities and/or routes based on the change in connectivity, thus allowing the switch fabric to converge sometime after FIBs 118 were updated to avoid routing traffic to broken link 122.

As shown in FIG. 1B, a broken link 142 between leaf switch 130 and a spine switch 148 in spine switches 120 is also detected at leaf switch 130. Leaf switch 130 may determine that an upstream leaf switch 146 in leaf switches 110 is connected to spine switch 148 and thus able to avoid broken link 142 (e.g., by routing traffic through other spine switches 120 that connect to leaf switch 130 instead of spine switch 148).

Next, leaf switch 130 may transmit an indication 142 of broken link 142 to leaf switch 146. As mentioned above, indication 142 may be communicated from leaf switch 130 to leaf switch 146 via an in-band protocol, a centralized controller, and/or another mechanism for communicating connectivity changes within a network. Indication 142 may additionally be transmitted to leaf switch 146 via a path that avoids broken link 126 (e.g., a path from leaf switch 130 to leaf switch 146 through any spine switches 120 that exclude spine switch 148).

In response to indication 144, leaf switch 146 may update locally stored routing information in a FIB 150 to avoid broken link 142. For example, leaf switch 146 may remove spine switch 148 from FIB 150 because traffic routed from leaf switch 146 to leaf switch 130 via spine switch 148 would encounter broken link 142. Once spine switch 148 is removed from

FIB 150, traffic may be routed within the switch fabric in a way that avoids broken link 142 (e.g., through other spine switches 120 connecting leaf switches 130 and 146). Leaf switch 130 and/or another component of the switch fabric may subsequently propagate another indication of broken link 142 to remaining switches in the switch fabric, thus allowing the remaining switches to converge in response to broken link 142.

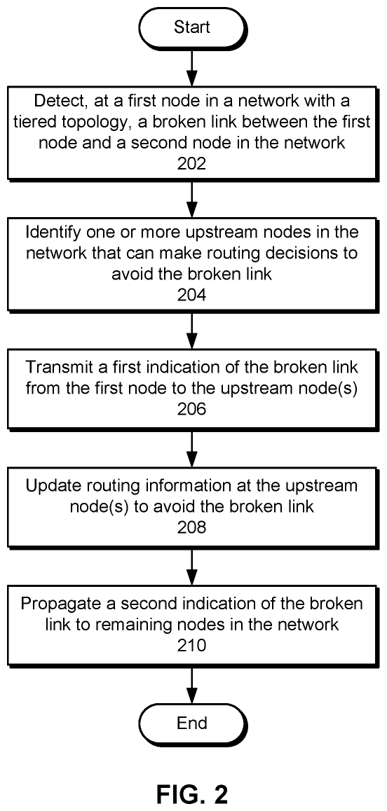

FIG. 2 shows a flowchart illustrating a process of managing a broken link in a network with a Clos topology in accordance with the disclosed embodiments. In one or more embodiments, one or more of the steps may be omitted, repeated, and/or performed in a different order. Accordingly, the specific arrangement of steps shown in FIG. 2 should not be construed as limiting the scope of the embodiments.

Initially, a first node in a network with a Clos topology detects a broken link between the first node and a second node in the network (operation 202). For example, the Clos topology may include a tier of ToR switches that connect a set of hosts to the network, a tier of leaf switches connected to the ToR switches, and/or a tier of spine switches connected to th leaf switches. As a result, the first and second nodes may include nodes in adjacent tiers of the network.

Next, one or more upstream nodes in the network that can make routing decisions to avoid the broken link are identified (operation 204). For example, the upstream nodes may include nodes that can route traffic on paths that contain the broken link or on paths that avoid the broken link. If the broken link is between a first node in the leaf tier and a second node in the spine tear, the upstream node(s) may be identified as one or more other nodes in the leaf tier that are connected to the second node in the spine tier. If the broken link is between a first node in the leaf tier and a second node in the ToR tier, the upstream node(s) may be identified as one or more other nodes in the ToR tier that are in the same independent fabric plane as the first and second nodes.

A first indication of the broken link is then transmitted from the first node to the upstream node(s) (operation 206). For example, the first node may communicate the broken link to a centralized controller, and the centralized controller may relay the broken link to the upstream node(s). In another example, the first node may use an in-band protocol with the upstream node(s) to transmit the first indication of the broken link to the upstream node(s). The first indication may additionally be communicated separately from link state messages and/or other types of messages that are propagated across the network to communicate a change in connectivity resulting from the broken link. As a result, the first indication may allow the upstream node(s) to avoid routing traffic to the broken link before the network converges.

After the first indication is received at the upstream node(s), routing information at the upstream node(s) is updated to avoid the broken link (operation 208). For example, each upstream node may remove paths containing the broken link from the node's local FIB. If the broken link is between a first node in the leaf tier and a second node in the spine tier, each upstream node may remove the second node from the upstream node's local FIB. If the broken link is between a first node in the leaf tier and a second node in the ToR tier, each upstream node may remove an independent fabric plane containing the broken link from the upstream node's local FIB.

Finally, a second indication of the broken link is propagated to some or all remaining nodes in the network (operation 210). For example, the second indication may include a link state message and/or other message that is propagated from the first node to neighbors of the first node, and from each node that received the second indication to additional neighbors, until the message is received by all nodes in the network. The nodes may use the message to recalculate reachabilities and/or paths in the network, allowing the network to converge sometime after operations 202-208 are performed to avoid the broken link.

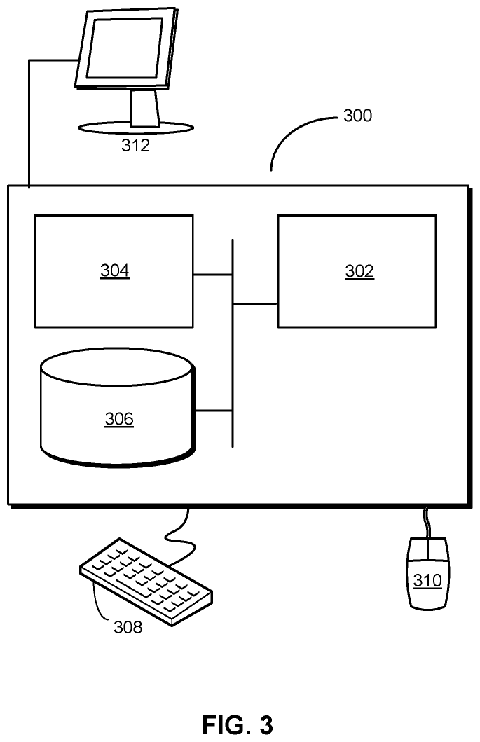

FIG. 3 shows a computer system 300. Computer system 300 includes a processor 302, memory 304, storage 306, and/or other components found in electronic computing devices. Processor 302 may support parallel processing and/or multi-threaded operation with other processors in computer system 300. Computer system 300 may also include input/output (I/O) devices such as a keyboard 308, a mouse 310, and a display 312.

Computer system 300 may include functionality to execute various components of the present embodiments. In particular, computer system 300 may include an operating system (not shown) that coordinates the use of hardware and software resources on computer system 300, as well as one or more applications that perform specialized tasks for the user. To perform tasks for the user, applications may obtain the use of hardware resources on computer system 300 from the operating system, as well as interact with the user through a hardware and/or software framework provided by the operating system.

In one or more embodiments, computer system 300 provides a system for managing a broken link in a network with a Clos topology, such as a network with a ToR tier, leaf tier, and/or spine tier. The system may include one or more nodes in the network. A first node in the network may detect the broken link between the first node and a second node in the network. Next, the first node and/or another node may identify one or more upstream nodes in the network that can make routing decisions to avoid the broken link. The first node and/or another node may then transmit a first indication of the broken link to the one or more upstream nodes without propagating the first indication to remaining nodes in the network. Finally, the upstream node(s) may update their routing information based on the first indication to avoid the broken link.

In addition, one or more components of computer system 500 may be remotely located and connected to the other components over a network. Portions of the present embodiments may also be located on different nodes of a distributed system that implements the embodiments. For example, the present embodiments may be implemented using a cloud computing system that provides accelerated convergence in a remote network with a Clos topology.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
detecting, at a first node in a network with a Clos topology, a broken link between the first node and a second node in the network;
identifying one or more upstream nodes in the network that can make routing decisions to avoid the broken link;
transmitting a first indication of the broken link to the one or more upstream nodes without propagating the first indication to remaining nodes in the network; and
updating, based on the first indication, routing information at the one or more upstream nodes to avoid the broken link.

2. The method of claim 1, further comprising:
propagating a second indication of the broken link to the remaining nodes in the network after the first indication is transmitted.

3. The method of claim 1, wherein updating the routing information at the one or more upstream nodes comprises:
removing paths containing the broken link from forwarding information bases (FIBs) at the one or more upstream nodes.

4. The method of claim 1, wherein the Clos topology comprises:
a top of rack (ToR) tier that connects a set of hosts to the network;
a leaf tier that connects the ToR tier and a spine tier; and
the spine tier comprising a set of independent fabric planes.

5. The method of claim 4, wherein:
the first node and the one or more upstream nodes are in the leaf tier; and
the second node is in the spine tier.

6. The method of claim 5, wherein updating the routing information at the one or more upstream nodes based on the broken link comprises:
removing the second node from the routing information at the one or more upstream nodes.

7. The method of claim 4, wherein:
the first node is in the leaf tier; and
the second node and the one or more upstream nodes are in the ToR tier.

8. The method of claim 7, wherein updating the routing information at the one or more upstream nodes based on the broken link comprises:
removing a plane containing the broken link from the routing information at the one or more upstream nodes.

9. The method of claim 1, wherein the first indication is transmitted using an in-band protocol between the first node and the one or more upstream nodes.

10. The method of claim 1, wherein the first indication is transmitted using a centralized controller for the network.

11. A system, comprising:
one or more processors; and
memory storing instructions that, when executed by the one or more processors, cause the system to:
detect, at a first node in a network with a Clos topology, a broken link between the first node and a second node in the network;
identify one or more upstream nodes in the network that can make routing decisions to avoid the broken link;
transmit a first indication of the broken link to the one or more upstream nodes without propagating the first indication to remaining nodes in the network; and
update, based on the first indication, routing information at the one or more upstream nodes to avoid the broken link.

12. The system of claim 11, wherein the memory further stores instructions that, when executed by the one or more processors, cause the system to:
propagate a second indication of the broken link to the remaining nodes in the network after the first indication is transmitted.

13. The system of claim 11, wherein updating the routing information at the one or more upstream nodes comprises:
removing paths containing the broken link from forwarding information bases (FIBs) at the one or more upstream nodes.

14. The system of claim 11, wherein the Clos topology comprises:
a top of rack (ToR) tier that connects a set of hosts to the network;
a leaf tier that connects the ToR tier and a spine tier; and
the spine tier comprising a set of independent fabric planes.

15. The system of claim 14, wherein:
the first node and the one or more upstream nodes are in the leaf tier; and
the second node is in the spine tier.

16. The system of claim 15, wherein updating the routing information at the one or more upstream nodes based on the broken link comprises:
removing the second node from the routing information at the one or more upstream nodes.

17. The system of claim 14, wherein:
the first node is in the leaf tier; and
the second node and the one or more upstream nodes are in the ToR tier.

18. The system of claim 17, wherein updating the routing information at the one or more upstream nodes based on the broken link comprises:
removing a plane affected by the broken link from the routing information at the one or more upstream nodes.

19. The system of claim 11, wherein the first indication is transmitted using at least one of:
an in-band protocol between the first node and the one or more upstream nodes; and
a centralized controller for the network.

20. A non-transitory computer-readable storage medium storing instructions that when executed by a computer cause the computer to perform a method, the method comprising:
detecting, at a first node in a network with a Clos topology, a broken link between the first node and a second node in the network;
identifying one or more upstream nodes in the network that can make routing decisions to avoid the broken link;
transmitting a first indication of the broken link to the one or more upstream nodes without propagating the first indication to remaining nodes in the network; and
updating, based on the first indication, routing information at the one or more upstream nodes to avoid the broken link.
